(19) United States
(12) Patent Application Publication
(10) Pub. No.: US 2019/0027289 A1
(43) Pub. Date: Jan. 24, 2019

(54) MAGNET ASSEMBLY, AND MAGNETIC PLASTIC PART FOR SUCH A MAGNET ASSEMBLY

(71) Applicants: Bomatec Management AG, Höri (CH); HELLA GmbH & Co. KGaA, Lippstadt (DE)

(72) Inventors: Jürgen Goltz, Höri (CH); Mathias Sparenberg, Lippstadt (DE)

(21) Appl. No.: 16/069,581

(22) PCT Filed: Jan. 15, 2016
(86) PCT No.: PCT/CH2016/000008

§ 371 Date: Jul. 12, 2018

(51) Int. Cl. H01F 7/02

(52) U.S. Cl. CPC H01F 7/021; G01L 3/104

(57) ABSTRACT

In a magnet assembly (1), as is used for measuring rotation angles and torques for example, a magnetic plastic part (2) is connected to a metal support sleeve (3) in such a way that the plastic part bears directly against flange elements (5, 6) of the support sleeve (3), and that formations (10, 11) on the plastic part establish a form-fit connection between the plastic part and the support sleeve which connects these in the direction of the common center longitudinal axis of plastic part and support sleeve. The form-fit connection itself may be nonreleasable and thus permanent, or additional blocking means may be provided which prevent release of the form-fit connection.

### CROSS-REFERENCE TO RELATED APPLICATION

This application is a National Stage application of International Patent Application No. PCT/CH2016/000008, filed on Jan. 15, 2016, which is hereby incorporated by reference in its entirety.

### TECHNICAL FIELD

The invention relates to a magnet assembly comprising a ring-shaped plastic part having magnetic properties, and a metal support sleeve which is situated coaxially with respect to the plastic part and permanently connected to the plastic part, and which has at least one flange element on an end-face side. The invention further relates to a plastic part, having magnetic properties, for such a magnet assembly.

### BACKGROUND

It is known to design the magnetic part of a magnet assembly, as used in particular for torque sensors and rotation angle sensors, as a so-called highly filled plastic part. Such a ring-shaped “plastic magnet” is connected to a metallic support sleeve that is used for mounting the magnet assembly having such a design on a shaft, which is part of the steering column of a vehicle, for example. EP 1 123 794 discusses an approach for connecting the magnetic plastic part to the metallic support sleeve or to a metallic base body, respectively, in which the plastic part is molded onto the base body. This approach according to EP 1 123 794 may result in the plastic body breaking off from the base body due to alternating heat load on the magnet assembly. For solving this problem, EP 1 123 794 proposes the provision of a further component in the form of an intermediate element, made of elastic plastic material, between the base body and the magnetic plastic part, so that the plastic part is connected to the metal base body not directly, but rather via the intermediate element. Such an approach is also proposed in DE 10 2008 047 466 A1, which likewise relates to a magnet assembly with a magnetic ring that is manufactured in a plastic injection molding process, and a metallic support sleeve for the magnetic ring. The stated approaches have proven satisfactory, but they are expensive in their manufacture.

### SUMMARY

The object of the invention is to provide a magnet assembly of the type stated at the outset which is resistant to alternating heat loads and is cost-effective to manufacture.

For the magnet assembly of the type stated at the outset, this object is achieved in that the plastic part with one of its end-face sides rests directly against the at least one flange element of the support sleeve, and by means of at least two formations on the plastic part, which protrude away from said end-face side of the plastic part, is connected in a form-fit manner to the one flange element or in a form-fit manner to the multiple flange elements of the support sleeve, so that the plastic part and the support sleeve are fixedly connected to one another in the coaxial direction via the form-fit connection.

It has been shown that a permanent connection is provided by such a form-fit and direct connection between the magnetic plastic part and the support sleeve. As a result of the direct connection, an intermediate element and the step for manufacturing same are dispensed with, which makes it more efficient and thus more cost-effective to manufacture the magnet assembly according to the invention.

The form-fit connection may be designed in such a way that a nonreleasable or in other words permanent form-fit connection results from the connection of the formations and the flange element or the flange elements. However, it is preferably provided that the formations and the flange element or the flange elements are connected in the manner of a bayonet lock, and that at least one blocking means is provided which blocks release of the bayonet lock-like connection.

The plastic part may have two mutually opposite formations, or three or four formations may be provided on the plastic part; in particular, the plastic part may have three or four equidistantly spaced formations. The formations are preferably formed in one piece on the plastic part. For the preferred connection of the plastic part and the support sleeve by means of a bayonet lock-like connection, the formations have an indentation that adjoins at the stated end face. It is particularly preferred that at least one of the indentations, in particular all of the indentations, extend(s) in a tapering manner, in each case observed in the side view. More preferably, the design is such that the flange is held in the indentation with a snug fit, or that the flange is held in the indentation with a press fit. The preferred manner results in a particularly good, simple direct connection between the plastic part and the support sleeve.

Moreover, it is preferred that the blocking means is formed by at least one blind hole in the plastic part, and a pin that blocks a rotational movement between the plastic part and the support sleeve about the center longitudinal axis thereof is pressed into the plastic part.

A further object of the invention is to provide a magnetic plastic part that allows simple, cost-effective mounting on a support sleeve.

This is achieved according to the invention in that the plastic part has a sleeve-shaped design and has at least two formations, formed in one piece on the plastic part, that protrude away from one of the end-face sides thereof.

Such a plastic part allows direct connection to a support sleeve by means of the formations, and thus achieves the advantages stated above for the magnet assembly.

Further advantageous embodiments of the plastic part result from the dependent claims.

Thus, for a magnet assembly having such a plastic part, as used for measuring rotation angles and torques, for example, a magnetic plastic part is connected to a metal support sleeve in such a way that the plastic part rests directly against flange elements of the support sleeve, and the formations on the plastic part establish a form-fit connection between the plastic part and the support sleeve which connects them in the direction of the shared center longitudinal axis of the plastic part and the support sleeve. The form-fit connection itself may be nonreleasable and thus permanent, or additional blocking means may be provided which prevent release of the form-fit connection.

### BRIEF DESCRIPTION OF THE DRAWINGS

Further embodiments, advantages, and applications of the invention result from the dependent claims and from the following description, with reference to the figures, which show the following:

FIGS. 1 through 9 show a first exemplary embodiment of the invention, wherein

FIG. 1 shows a side view of the plastic part;

FIG. 2 shows a top view of the plastic part, with a view of the end face of the plastic part that makes direct contact with the support sleeve;

FIG. 3 shows an diagrammatic view of the ring-shaped plastic part;

FIG. 4 shows a side view of the support sleeve;

FIG. 5 shows a top view of the support sleeve;

FIG. 6 shows an diagrammatic view of the support sleeve;

FIG. 7 shows a side view of the magnet assembly;

FIG. 8 shows a top view of the magnet assembly with a view of the support sleeve;

FIG. 9 shows an diagrammatic view of the magnet assembly made up of the plastic element and the support sleeve;

FIGS. 10 through 18 show a second exemplary embodiment of the invention, wherein

FIG. 10 shows a side view of the plastic part;

FIG. 11 shows a top view of the plastic part, with a view of the end face of the plastic part that makes direct contact with the support sleeve;

FIG. 12 shows an diagrammatic view of the ring-shaped plastic part;

FIG. 13 shows a side view of the support sleeve;

FIG. 14 shows a top view of the support sleeve;

FIG. 15 shows an diagrammatic view of the support sleeve;

FIG. 16 shows a side view of the magnet assembly;

FIG. 17 shows a top view of the magnet assembly with a view of the support sleeve;

FIG. 18 shows an diagrammatic view of the magnet assembly made up of the plastic element and the support sleeve; and

FIG. 19 shows another embodiment which shows a top view of the magnet assembly with a view of the support sleeve, indicating the differences from the second embodiment.

### DETAILED DESCRIPTION

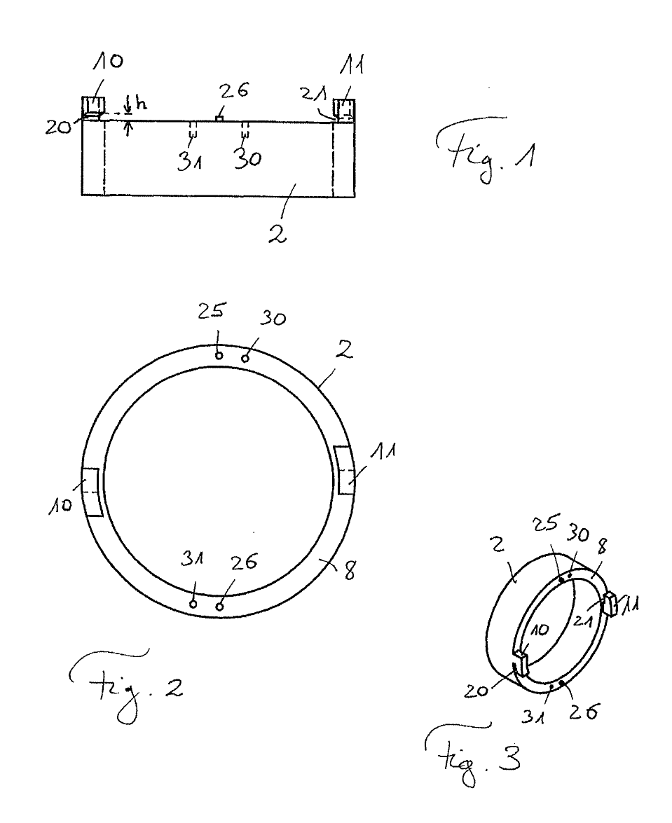

A first exemplary embodiment of the invention is explained with reference to FIGS. 1 through 9.

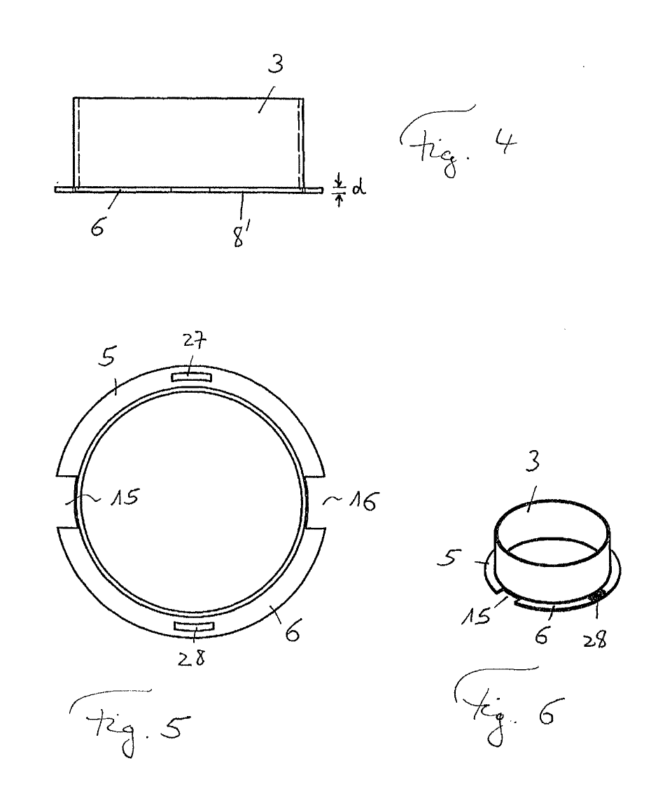

FIG. 3 shows a diagrammatic view by way of example of a ring-shaped plastic part 2 of the magnet assembly, which has magnetic properties and in particular is a plastic-bonded permanent magnet. Such plastic-bonded permanent magnets, as well as their manufacture by injection molding, are known to those skilled in the art. Along its circumference, the plastic-bonded permanent magnet has a sequence of magnetic north poles and south poles which may be detected in a rotation angle and torque measuring system of magnetic field sensors. This is also known to those skilled in the art, and is not discussed in further detail here.

According to the invention, the ring-shaped plastic part has at least two formations on one of its end-face sides. In the example of the plastic part in FIG. 3, these are two diametrically opposed formations 10 and 11 which emanate from the end-face side 8 of the plastic part 2. The formations are formed in one piece with the ring-shaped main body of the plastic part. They are thus formed during the injection molding of the plastic part, and likewise have magnetic properties. The location of the formations along the circumference of the ring-shaped plastic part is preferably selected in such a way that a magnetic north pole and a magnetic south pole are also present in each of the formations. FIGS. 1 and 2 show the plastic part together with its formations in a side view and a top view, respectively.

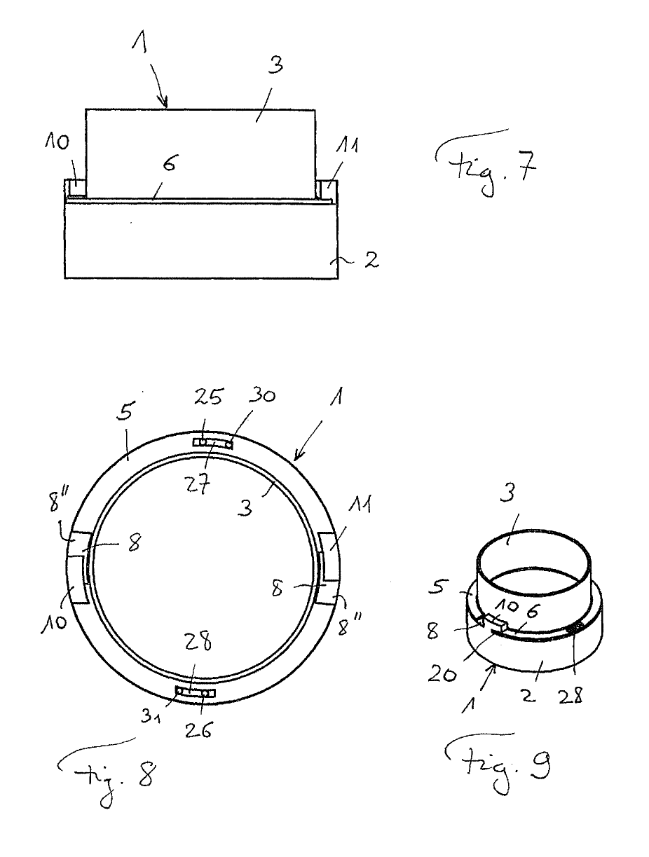

FIG. 6 illustrates diagrammatically an example of a support sleeve 3 of the magnet assembly. This support sleeve 3 has two flange elements 5 and 6 which extend opposite one another along the circumference of the support sleeve. A gap 15 or 16 is provided between the two flange elements. Each gap is large enough that the formations 10 or 11 of the plastic part 2 can be guided through, thus allowing a bayonet lock-like connection of the part 2 and the sleeve 3, as explained below. FIGS. 4 and 5 show the support sleeve in a side view and a top view, respectively. In the side view in FIG. 4, the end-face side 8′ denotes the flange element with which the end-face side 8 of the plastic part makes direct contact in the magnet assembly. The rear side of this end-face side 8′ is apparent in FIGS. 5 and 6. Instead of a support sleeve having multiple flange elements that are separated by gaps, a single, continuous flange could be provided, which instead of the gaps has recesses through which the formations on the plastic part may be inserted.

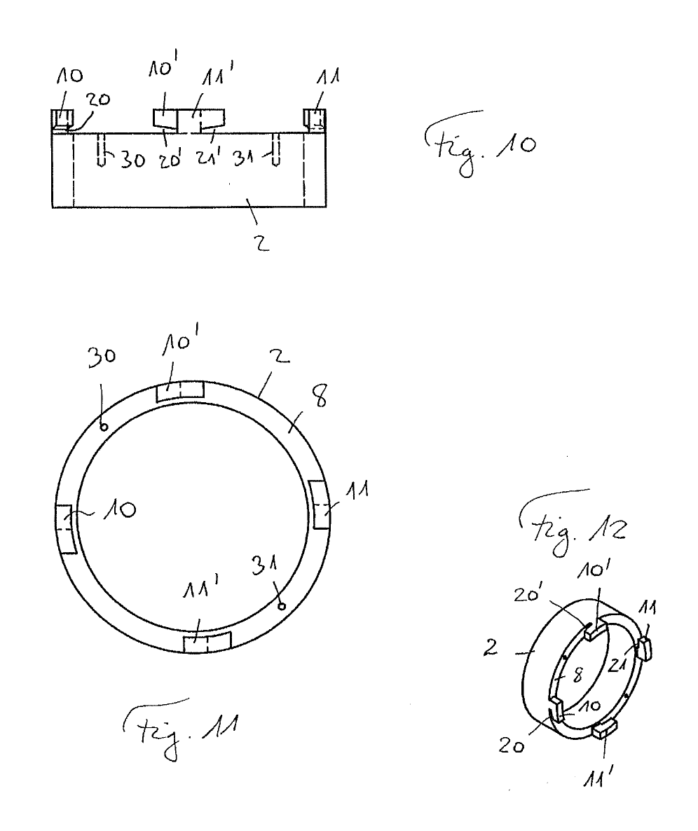

FIG. 9 shows the magnet assembly 1, in which the magnetic plastic part 2 and the support sleeve 3 are permanently connected to one another. The plastic part and the support sleeve are coaxially situated, and their center longitudinal axes thus lie on the same straight line. The formations on the plastic part engage with the flange element in a form-fit manner, so that according to the invention a fixed connection in the direction of the center longitudinal axes results. If the form-fit connection is designed as a connection that is no longer releasable, the connection is thus already established.

In the illustrated exemplary embodiment, the connection is established in the manner of a bayonet lock, which is also the case for the subsequent exemplary embodiments. This is one preferred type of connection. In FIGS. 1 through 3 showing the plastic part 2, it is apparent that the formation 10 or 11 has an indentation 20 or 21, respectively, that extends between the end face 8 and the formation 10 or 11. The height h of the indentation (FIG. 1) essentially corresponds to the thickness d of the flange element (FIG. 4), or preferably extends in such a way that the height h, viewed from the side, decreases toward the end of the indentation, as explained in greater detail below. The indentation 20 or 21 thus allows the bayonet lock-like connection of the plastic part and the flange elements, as illustrated in FIG. 9 as well as in the top view of the magnet assembly 1 according to FIG. 8 and the side view of the magnet assembly 1 according to FIG. 7. This takes place in such a way that after the formations 10 and 11 are introduced into the corresponding gap 15 or 16, in which the end face 8 of the plastic part comes to rest against the end faces 8′ of the flange elements, a relative rotational movement between the plastic part 2 and the support sleeve 3 takes place, in which the flange element 6 with its section adjoining the gap 15 has been introduced into the indentation 20 or has been brought into a form-fit connection with the formation 10. Accordingly, due to the rotation, the flange element 5 with its section adjoining the gap 16 has been introduced into the indentation 21, and therefore the form-fit connection has also been established between the formation 11 and the flange element 5 in the direction of the center longitudinal axis. The dimensioning of the formations and of the flange elements is selected in such a way that a sufficiently tight contact of the end face 8 with the end faces 8′ results from the form-fit connection. The indentations 20 and 21, viewed in the side view, are preferably designed with a decreasing height, with the greater height at the start of the indentation, so that increasing contact or pressing of the plastic element 2 against the support sleeve 3 results during the rotational movement. The height h at the end of the indentation may be selected to correspond exactly to the thickness of the flange, so that a firm seat (snug fit) of the flange in the indentation results at that location, or the height h of the indentation at the end of the indentation may even be selected to be slightly smaller than the thickness of the flange, so that the formation is slightly elastically deformed when the rotational movement has concluded, so that a press fit of the flange results at that location.

In the exemplary embodiment shown, joining together the plastic part 2 and the support sleeve 3 in the correct position is facilitated in that in each case a further formation, designed here as a simple cylindrical stud, is provided on the plastic part 2 along the end face 8 between the formations 10 and 11 which assists with centering the two components 2 and 3 during assembly, in that the studs 25 and 26 engage in corresponding elongated holes 27 and 28, respectively. The elongated holes are dimensioned in such a way that the studs do not hinder the rotational movement.

Since the bayonet lock-like connection selected in this exemplary embodiment brings about the form-fit connection, this connection must be blocked from counter-rotation, since the aim here is to achieve a permanent connection, not a releasable bayonet lock. Such blocking against a releasing rotational movement may already be provided by sufficiently strong frictional locking between the plastic part and the support sleeve due to the described connection. However, it is preferred to provide at least one blocking means that blocks the counter-rotation.

Appropriate blocking means that secure the established connection from release could be a detent connection for at least one of the formations 10, 11 and the associated flange element 5 or 6. Such a detent between the formation and the flange element may have any design known to those skilled in the art. Alternatively or additionally, a chemical blocking means in the form of a partial adhesive application could be provided, in particular at a location 8″ or at both locations 8″ (FIG. 8) at which the end face 8 is exposed, so that an elevation formed by the adhesive at this location blocks the formation 10 or 11 or both formations from counter-rotation. In the example shown, the blocking means is designed as a pin or two pins, which is/are pressed into the plastic part and prevent(s) counter-rotation of the plastic part 2 and the support sleeve 3. Thus (and also via the other stated blocking means), the bayonet lock-like connection becomes a permanent, i.e. nonreleasable, connection, which is essential for the present invention. In the example shown, blind holes 30 and 31 are provided in the plastic part 2, which in the magnet assembly 1 are accessible through the particular elongated hole 27 or 28 at one respective end, as is apparent in FIG. 8. If a pin (not illustrated) is pressed in each case into this blind hole so that the pin still protrudes from the blind hole, this results in blocking of the counter-rotation of the plastic part 2 and the support sleeve 3. The pins are preferably made of a nonmagnetic metal material. This blocking is indicated only by a black area in FIG. 9, and is not shown in detail.

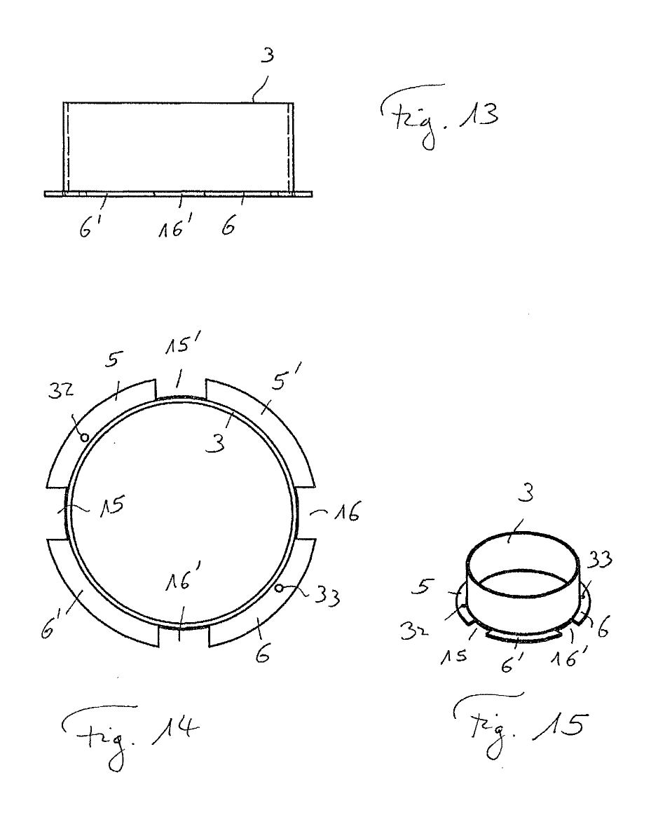

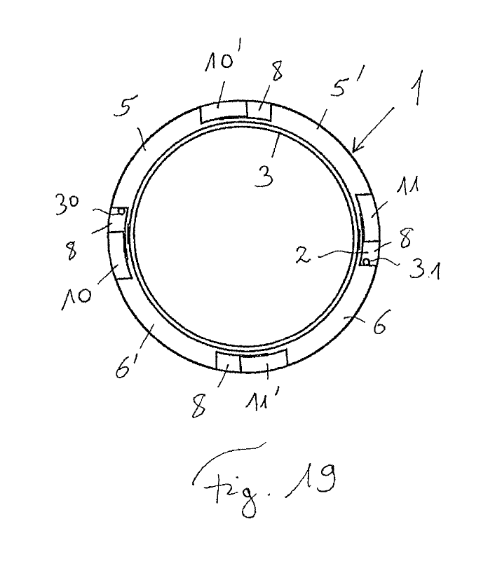

Another exemplary embodiment is explained with reference to FIGS. 10 through 18. Identical or functionally equivalent components are denoted by the same reference numerals as in the previous example. FIG. 12 shows the plastic part 2 in a diagrammatic view. In this embodiment, four formations are provided on the plastic part 2, so that the formations 10′ and 11′ are present in addition to the formations 10 and 11. The formations likewise protrude from the end face 8. In the present example, they are uniformly distributed along the end face. These formations also have indentations 20 and 21 as well as 20′ and 21′ which allow a bayonet lock-like connection, as in the previous example. In this embodiment, however, centering studs as in the previous example are not provided, since the centering and assembly of the plastic part 2 and the support sleeve are simple due to the additional formations. Blind holes 30 and 31 for a blocking means are provided along the end face 8, but at a different location. In the side view of the indentations 20′ and 21′ in FIG. 10, it is clearly apparent that they extend in a tapering manner, as preferred, with the greater height at the start of the indentation. The comments made for the previous example apply; in particular, the particular flange may be held with a snug fit or a press fit at that location.

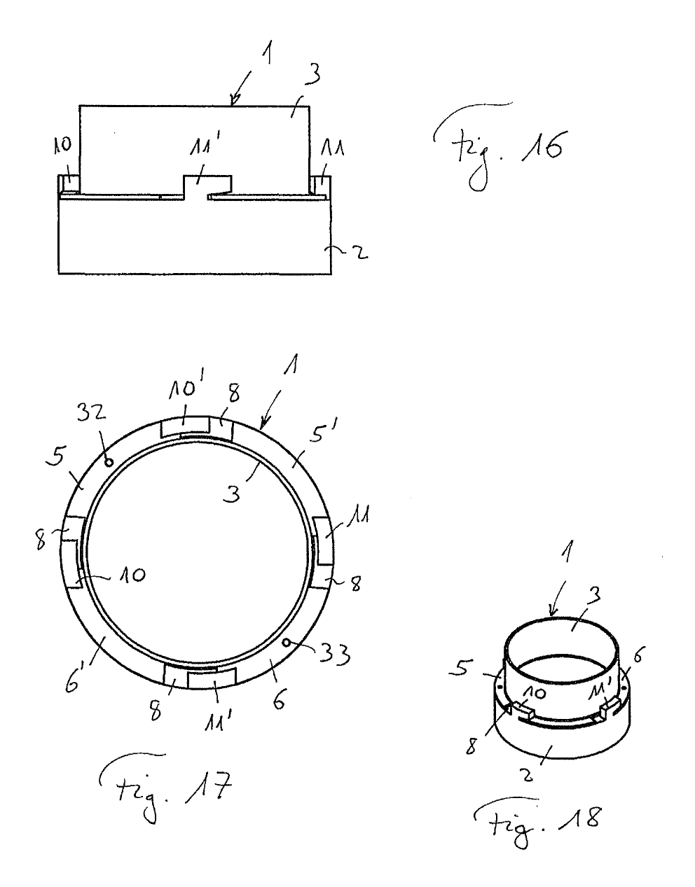

In this example, the support sleeve 3 has four flange elements 5, 5′ and 6, 6′ which are separated from one another by the gaps 15, 16 and 15′ and 16′, as is apparent in particular in FIG. 14. In this example, the support sleeve has a borehole 32 and 33 in the two flange elements 5 and 6, respectively, which in each case allows a pin to be guided through as a blocking means. FIG. 18 shows the magnet assembly 1 that has been formed by connecting the plastic part 2 and the support sleeve 3. This likewise takes place by rotating the components 2 and 3 relative to one another after the formations 10, 11 and 10′, 11′ have been inserted into the associated gaps, in order to bring the indentations in the formations and the associated sections of the flange elements into a form-fit connection to establish the fixed connection in the direction of the center longitudinal axis. Here as well, at least one drop of an adhesive could be provided as a blocking means. However, the illustrated approach for the blocking means is preferred, in which, to establish the form-fit connection, the blind holes 30 and 31 are in flush alignment with the boreholes 32 and 33 in the plastic part 2 after the components 2 and 3 are rotated, so that a pin that prevents counter-rotation is also pressed into at least one blind hole or into both blind holes through the respective borehole.

FIG. 19 shows another exemplary embodiment for which only the top view of the magnet assembly 1 is illustrated. For the form-fit connection, this example corresponds to the example in FIGS. 10 through 18. However, as the blocking means, at least one blind hole is provided which after the rotation is accessible in a gap between two flange elements. Two blind holes are illustrated in this example. A pin may be pressed into at least one of the blind holes to form the blocking means.

As previously mentioned, the pins of the blocking means are preferably made of a nonmagnetic material. It was likewise mentioned that the formations on the magnetic plastic part are preferably situated above a boundary at which a north pole adjoins a south pole along the circumference of the end face. It is preferred that the formation correspondingly partially includes a north pole and partially includes a south pole, or in other words that the boundary between the two poles also extends through the formation.

In a magnet assembly according to the invention as used for measuring rotation angles and torques, for example, a magnetic plastic part is thus connected to a metal support sleeve in such a way that the plastic part rests directly against flange elements of the support sleeve, and that formations on the plastic part establish a form-fit connection between the plastic part and the support sleeve which connects them in the direction of the shared center longitudinal axis of the plastic part and the support sleeve. The form-fit connection itself may be nonreleasable and thus permanent, or additional blocking means may be provided which prevent release of the form-fit connection.

Although preferred embodiments of the invention are described in the present patent application, it is explicitly noted that the invention is not limited to same, and may also be carried out in some other way within the scope of the following claims.

What is claimed is:

1. A magnet assembly comprising a ring-shaped plastic part having magnetic properties, and a metal support sleeve which is situated coaxially with respect to the plastic part and permanently connected to the plastic part, and which has at least one flange element on the end-face side, wherein the plastic part with one of its end-face sides rests directly against the at least one flange element of the support sleeve, and by means of at least two formations on the plastic part, which protrude away from said end-face side of the plastic part, is connected in a form-fit manner to the one flange element or in a form-fit manner to the multiple flange elements of the support sleeve, so that the plastic part and the support sleeve are fixedly connected to one another in the coaxial direction via the form-fit connection.

2. The magnet assembly according to claim 1, wherein the formations and the flange element or the flange elements are connected in the manner of a bayonet lock, and that at least one blocking means is provided which blocks release of the bayonet lock-like connection.

3. The magnet assembly according to claim 1, wherein the plastic part has two mutually opposite formations.

4. The magnet assembly according to claim 1, wherein the plastic part has three or four formations, in particular, that the plastic part has three or four equidistantly spaced formations.

5. The magnet assembly according to claim 1, wherein the formations are formed in one piece on the plastic part.

6. The magnet assembly according to claim 1, wherein the formations have an indentation that adjoins at the stated end face.

7. The magnet assembly according to claim 6, wherein at least one of the indentations, in particular all of the indentations, extend(s) in a tapering manner, in each case observed in the side view.

8. The magnet assembly according to claim 7, wherein the flange is held in the indentation with a snug fit, or that the flange is held in the indentation with a press fit.

9. The magnet assembly according to claim 2, wherein the blocking means is formed by at least one blind hole in the plastic part, and a pin that blocks a rotational movement between the plastic part and the support sleeve about the center longitudinal axis thereof is pressed into the plastic part.

10. A magnetic plastic part for a magnet assembly according to claim 1, wherein the plastic part has a sleeve-shaped design and has at least two formations, formed in one piece on the plastic part, that protrude away from one of the end-face sides thereof.

11. The magnetic plastic part according to claim 10, wherein two mutually opposite formations are provided.

12. The magnetic plastic part according to claim 10, wherein three or four formations are provided which are uniformly distributed along the circumference of the end-face side.

13. The magnetic plastic part according to claim 10, wherein at least one of the formations, in particular all of the formations, is/are provided with an indentation which adjoins the end-face side of the plastic part and which, in a side view of the formation, converges toward the end of the indentation.

14. The magnet assembly according to claim 2, wherein the plastic part has two mutually opposite formations.

15. The magnet assembly according to claim 2, wherein the plastic part has three or four formations, in particular, that the plastic part has three or four equidistantly spaced formations.

16. The magnet assembly according to claim 2, wherein the formations are formed in one piece on the plastic part.

17. The magnet assembly according to claim 3, wherein the formations are formed in one piece on the plastic part.

18. The magnet assembly according to claim 4, wherein the formations are formed in one piece on the plastic part.

19. The magnet assembly according to claim 2, wherein the formations have an indentation that adjoins at the stated end face.

20. The magnet assembly according to claim 3, wherein the formations have an indentation that adjoins at the stated end face.
